(19) United States
(12) Patent Application Publication
(10) Pub. No.: US 2024/0315176 A1
(43) Pub. Date: Sep. 26, 2024

(54) PLANT FULL-CYCLE GROWTH ILLUMINATING DEVICE

(71) Applicant: FULTON SCIENCE AND TECHNOLOGY LIGHTING CO., LTD, SHENZHEN (CN)

(72) Inventors: PEI DONG, SHENZHEN (CN); ZHIQIANG XUE, SHENZHEN (CN)

(21) Appl. No.: 18/495,777

(22) Filed: Oct. 27, 2023

(30) Foreign Application Priority Data
Mar. 20, 2023 (CN) 202310278269.5

(51) Int. Cl. A01G 7/04; H05B 45/10; H05B 47/11

(52) U.S. Cl. CPC A01G 7/045; H05B 45/10; H05B 47/11

(57) ABSTRACT

A plant full-cycle growth illuminating device includes a control circuit, a first LED component, and a second LED component. The first LED component and the second LED component are respectively connected to the control circuit. The control circuit is configured to obtain a user instruction and respectively control a light output intensity of a first combined spectrum and a light output intensity of a second combined spectrum according to the user instruction, which meet spectral needs of plants in different growth stages of a whole growth circle. Moreover, the first combined spectrum and the second combined spectrum are independent from each other and do not affect each other. The control circuit is simple and low in cost and is flexible to use.

### TECHNICAL FIELD

The present disclosure relates to a technical field of plant assisted growth, and in particular to a plant full-cycle growth illuminating device.

### BACKGROUND

According to the principle that plants need sunlight for photosynthesis, a carbon plant growth illuminating device is created to simulate sunlight or completely replace sunlight to provide light for carbon based plants. At present, with development of photobiological regulation technology, illuminating methods adopted for plant growth are no longer single. For different plants or different growth stages of a same plant, different control measures are taken, and different spectra are applied for irradiations.

For example: Photobiological studies show that in an early stage of plant growth, a large amount of blue light spectrum is required for growth of plant roots, stems, and leaves. In a later stage of plant growth, for plants harvesting flowers or fruits, Photobiological studies show it is generally necessary to apply infrared or ultraviolet light for short-term induction of the plants. Therefore, a plant growth illuminating device needs to have a variety of spectra.

At present, the plants cultivated by artificial light mainly include leafy vegetables, solanaceous vegetables, medicinal plants, hemp plants, flower plants, bulk economic crops, high-value shrubs, etc. The prior art discloses distribution characteristics of spectral energy of different plants at different growth stages, such as peak wavelength, R/B, R/FR, and even specific energy distribution data for specific growth stages of specific plants. However, the prior art does not disclose a spectrum that meets common and healthy growth of the above various plants, nor does it disclose a device meeting spectral requirements of different growth stages of the plants.

In addition, because different types of plants have different requirements for light environments, energy efficiency of effective conversion is extremely low and energy is greatly wasted, resulting in a substantial increase in costs of artificial light indoor cultivation of the plants. Therefore, based on the above reasons, light-emitting diodes (LEDs) and related solid-state lighting (SSL) are served as potentially feasible and promising tools for plant illuminating, where LEDs have high luminous efficacy, long life, narrow spectrum, strong spectral selectivity. and many other advantages. However, commercial high-brightness LED products have a main spectrum in a green-yellow wavelength range of 400-700 nm, which has an efficient response to human vision and cannot effectively respond to the photosynthesis process. To overcome this defect, according to the technical principle in the prior art, a spectrum that responds efficiently to photosynthesis is realized by combining different types of semiconductors or photoluminescent materials such as GaN, GaAs, GaP.

### SUMMARY

A main purpose of the present disclosure is to propose a plant full-cycle growth illuminating device that solves a technical problem that a conventional illuminating device cannot meet illuminating requirements of a whole growth circle of plants.

To achieve the above purpose, the present disclosure provides the plant full-cycle growth illuminating device. The plant full-cycle growth illuminating device comprises a control circuit, a first LED component, and a second LED component.

The first LED component and the second LED component are respectively connected to the control circuit. The first LED component outputs a first combined spectrum when the first LED component is lit. The second LED component outputs a second combined spectrum when the second LED component is lit up. The control circuit is configured to obtain a user instruction and respectively control a light output intensity of the first combined spectrum and a light output intensity of the second combined spectrum according to the user instruction. The first combined spectrum and the second combined spectrum have different spectral compositions.

Optionally, the plant full-cycle growth illuminating device further comprises a first power supply circuit and a second power supply circuit. The first power supply circuit is connected to the first LED component and the control circuit, and the second power supply circuit is connected to the second LED component and the control circuit.

The control circuit is configured to determine a first combined spectrum control signal and a second combined spectrum control signal according to the user instruction.

The first power supply circuit is configured to supply power to the first LED component according to the first combined spectrum control signal, so as to adjust the light output intensity of the first combined spectrum.

The second power supply circuit is configured to supply power to the second LED component according to the second combined spectrum control signal, so as to adjust the light output intensity of the second combined spectrum.

Optionally, the plant full-cycle growth illuminating device is configured to implement an illuminating method. The illuminating method comprises:
illuminating plants in a seedling stage with the first combined spectrum;
illuminating the plants in a growing stage with the first combined spectrum; and
illuminating the plants in a flowering stage with the first combined spectrum and the second combined spectrum.

Optionally, the illuminating method further comprises:
determining an illumination receiving surface covered by the first LED component and the second LED component;
determining a quantity of first target light quanta in the illumination receiving surface according to a real-time growth stage;
obtaining a quantity of actual light quanta of the illumination receiving surface; and
adjusting the light output intensity of the first combined spectrum and the light output intensity of the second combined spectrum when the quantity of the actual light quanta is less than the quantity of the first target light quanta, enabling the quantity of the actual light quanta in the illumination receiving surface is not less than the quantity of the first target light quanta.

Optionally, the illuminating method further comprises:
obtaining environmental parameters of the illumination receiving surface, where the environmental parameters comprises a temperature, a humidity, a CO₂ concentration, and a wind speed;
determining a quantity of second target light quanta in an illumination receiving surface according to a real-time growth stage and the environmental parameters; and
adjusting the light output intensity of the first combined spectrum and the light output intensity of the second combined spectrum according to the quantity of the second target light quanta, so that photosynthesis efficiency of the plant in the illumination receiving surface is maximized.

Optionally, the plant full-cycle growth illuminating device further comprises a third LED component and a fourth LED component. The third LED component and the fourth LED component are respectively connected to the control circuit.

The third LED component outputs a third combined spectrum when the third LED component is lit up. The fourth LED component outputs a fourth combined spectrum when the fourth LED component is lit. up

The control circuit is further configured to respectively control a light output intensity of the third combined spectrum and a light output intensity of the fourth combined spectrum according to the user instruction.

Optionally, the first LED component comprises a first white lamp and a first red lamp. The second LED component comprises a second white lamp, a second red lamp, a third far infrared lamp, and an ultraviolet lamp. A spectrum of the first white lamp and a spectrum of the first red light form the first combined spectrum. A spectrum of the second white lamp, a spectrum of the second red lamp, a spectrum of the third far infrared lamp, and a spectrum of the ultraviolet lamp form the second combined spectrum.

Optionally, the control circuit comprises a controller and a multi-channel dimmer. The controller is connected to the multi-channel dimmer, and the multi-channel dimmer is connected to the first LED component and the second LED component. The controller is configured to obtain the user instruction and output a plurality of dimming signals corresponding to the first LED component and the second LED component according to the user instruction. The multi-channel dimmer is configured to output the plurality of dimming signals respectively to the first LED component or the second LED component, so as to separately control the first LED component and the second LED component.

Compared with the prior art, according to technical solutions provided in the present disclosure, the plant full-cycle growth illuminating device comprises the first LED component and the second LED component, the first LED component outputs the first combined spectrum when the first LED component is lit up, and the second LED component outputs the second combined spectrum when the second LED component is lit up, so that the user is able to flexibly output different user instructions according to different growth stages of the plants in use, and the control circuit respectively controls the light output intensity of the first combined spectrum and the light output intensity of the second combined spectrum according to different user instructions. In the present disclosure, the light output intensity of the first combined spectrum and the light output intensity of the second combined spectrum are combined in different proportions according to different user instructions, so as to meet spectral requirements of the plants in different growth stages of the whole growth circle. Therefore, when the plants are planted and cultivated, there is no need to replace the plant full-cycle growth illuminating device or a planting site at different growth stages of the plants. Therefore, the technical problem that the conventional plant growth illuminating device cannot meet the illuminating requirements of the whole growth circle of the plants is solved.

### BRIEF DESCRIPTION OF DRAWINGS

FIG. 1 is a schematic diagram of a plant full-cycle growth illuminating device according to one embodiment of the present disclosure.

FIG. 2 is a schematic diagram of the plant full-cycle growth illuminating device according to another embodiment of the present disclosure.

FIG. 3 is a schematic diagram of a first combined spectrum in an illuminating method of the plant full-cycle growth illuminating device of the present disclosure.

FIG. 4 is a schematic diagram of a second combined spectrum in the illuminating method of the plant full-cycle growth illuminating device of the present disclosure.

FIG. 5 is a flow chart of the illuminating method of the plant full-cycle growth illuminating device of the present disclosure.

FIG. 6 is a schematic diagram of the plant full-cycle growth illuminating device according shown in a first mounting state.

FIG. 7 is a schematic diagram of the plant full-cycle growth illuminating device according shown in a second mounting state.

FIG. 8 is a schematic diagram of a full mixed spectrum of the first combined spectrum and the second combined spectrum of the plant full-cycle growth illuminating device of the present disclosure.

### DETAILED DESCRIPTION

In order to enable those skilled in the art to understand technical solutions in the present disclosure, technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure.

It should be noted that when one component is referred to as being “fixed on” or “disposed on” another component, it can be directly disposed on the other component or it may be indirectly fixed or disposed on the other component through a third component. When one component is said to be “connected to” another component, it may be directly connected to the other component or it may be indirectly connected to the other component.

It should be understood that in the description of the present disclosure terms such as “central”, “lateral”, “lengthways”, “length”, “width”, “thickness”, “upper”, “lower”, “left”, “right”, “vertical”, “horizontal”, “top”, “bottom”, “inner”, “outer”, “clockwise”, “counterclockwise”, etc., indicate direction or position relationships shown based on the drawings, and are only intended to facilitate the description of the present disclosure and the simplification of the description rather than to indicate or imply that the indicated device or element must have a specific direction or constructed and operated in a specific direction, and therefore, shall not be understood as a limitation to the present disclosure.

In addition, terms such as “first” and “second” are only used for the purpose of description, rather than being understood to indicate or imply relative importance or hint the number of indicated technical features. Thus, the feature limited by “first” and “second” can explicitly or impliedly include one or more features. In the description of the present disclosure, the meaning of “a plurality of” is two or more unless otherwise specified.

It is noted that structures, proportions, sizes, and the like shown in the drawings of the present specification are only used to cooperate with the contents disclosed in the description, so as to be understood and read by those skilled in the art, and are not intended to limit the limiting conditions that can be implemented by the present disclosure, so that the technical content disclosed in the present disclosure should still fall within the scope covered by the technical content disclosed in the present disclosure without affecting the effect and the purpose that can be achieved in the present disclosure.

In order to solve a technical problem that a conventional illuminating device cannot meet illuminating requirements of a whole growth circle of plants, the present disclosure provides the plant full-cycle growth illuminating device.

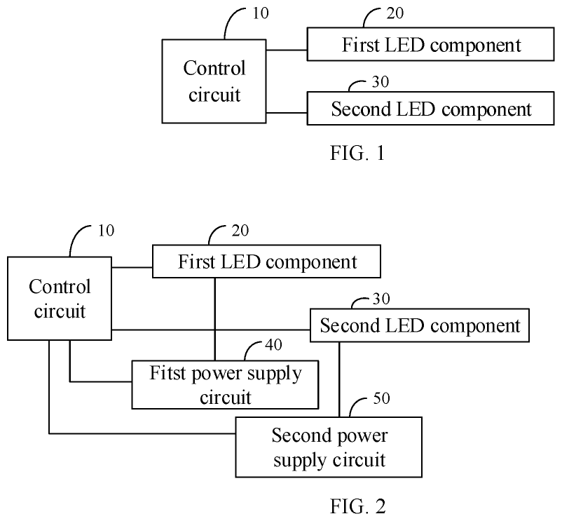

As shown in FIG. 1, in one optional embodiment, the plant full-cycle growth illuminating device comprises a control circuit 10, a first LED component 20, and a second LED component 30. The first LED component 20 and the second LED component 30 are respectively connected to the control circuit 10.

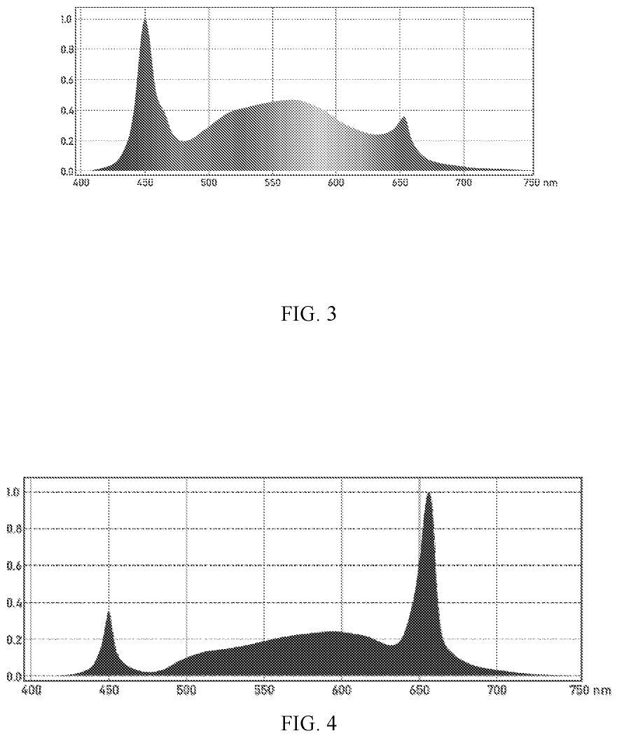

The first LED component 20 outputs a first combined spectrum when the first LED component 20 is lit up. The second LED component 30 outputs a second combined spectrum when the second LED component 30 is lit up. The control circuit 10 is configured to obtain a user instruction and respectively control a light output intensity of the first combined spectrum and a light output intensity of the second combined spectrum according to the user instruction. The first combined spectrum and the second combined spectrum have different spectral compositions. FIG. 3 is a schematic diagram of the first combined spectrum in an illuminating method of the plant full-cycle growth illuminating device. FIG. 4 is a schematic diagram of the second combined spectrum in the illuminating method of the plant full-cycle growth illuminating device of the present disclosure.

In the embodiment, the plant full-cycle growth illuminating device comprises the first LED component 20 and the second LED component 30, the first LED component 20 outputs the first combined spectrum when the first LED component 20 is lit up, and the second LED component 30 outputs the second combined spectrum when the second LED component 30 is lit up, so that the user is able to flexibly output different user instructions according to different growth stages of the plants in use, and the control circuit 10 respectively controls the light output intensity of the first combined spectrum and the light output intensity of the second combined spectrum according to different user instructions. In the present disclosure, the light output intensity of the first combined spectrum and the light output intensity of the second combined spectrum are combined in different proportions according to different user instructions, so as to meet spectral requirements of the plants in different growth stages of the whole growth circle. Therefore, when the plants are planted and cultivated, there is no need to replace the plant full-cycle growth illuminating device or a planting site at different growth stages of the plants. Therefore, the technical problem that the conventional plant growth illuminating device cannot meet the illuminating requirements of the whole growth circle of the plants is solved.

Therefore, the plant full-cycle growth illuminating device of the present disclosure provides a growth light source needed by the plants for healthy growth during the whole growth circle of the plants, such as artificially cultivated plants. The growth light source provides light needed for a whole circle of normal growth and development of the plants in an environment without natural light. The spectra generated by the plant full-cycle growth illuminating device meet the requirements of high-efficiency photosynthesis, have obvious functions of increasing a yield of the plants and improving quality of the plants compared with conventional fluorescent lamps or high pressure sodium lamps (HPS), increase a proportion of spectrum energy that is beneficial to photosynthesis, morphogenesis, reproductive development, etc. in the spectra generated by the plant full-cycle growth illuminating device, and reduce a proportion of spectra having low plant utilization and less impact on the plants.

In the embodiment, the present disclosure provides the plant full-cycle growth illuminating device that is more accurate than the conventional plant growth illuminating device in the prior art, has more adjustment parameter types and combinations. and avoids frequently control of illumination parameters during the whole growth circle of the plants caused by adjustments of too many types of parameters. Further, while the present disclosure does not reduce a control effect of a specific spectrum or illuminating parameters, the present disclosure more accurately carries out targeted spectral illuminating to the plants in different growth stages, and realizes fine control of plant growth directions of the plants, so as to accurately, efficiently, and directionally promote plant growth. By outputting a combination of the first combined spectrum with different light output intensities and the second combined spectrum with different light output intensities according to different proportions, the spectral requirements of the plants in different growth stages of the whole growth cycle are met. At the same time, there is no need to replace the plant full-cycle growth illuminating device or the planting site, which greatly reduces site and labor costs, and avoids double or multiple costs of purchasing different lamps at different growth stages of the plants.

Optionally, as shown in FIG. 2, the plant full-cycle growth illuminating device further comprises a first power supply circuit 40 and a second power supply circuit 50. The first power supply circuit 40 is connected to the first LED component 20 and the control circuit 10, and the second power supply circuit 50 is connected to the second LED component 30 and the control circuit 10.

The control circuit 10 is configured to determine a first combined spectrum control signal and a second combined spectrum control signal according to the user instruction. The first power supply circuit 40 is configured to supply power to the first LED component 20 according to the first combined spectrum control signal, so as to adjust the light output intensity of the first combined spectrum. The second power supply circuit 50 is configured to supply power to the second LED component 30 according to the second combined spectrum control signal, so as to adjust the light output intensity of the second combined spectrum. In the embodiment, independent power supply of the first LED component 20 and independent power supply of the second LED component 30 are realized, thereby avoiding mutual influence of the first power supply circuit 40 and the second power supply circuit 50, and avoids a burden on a single power supply caused by large-scale use of the first LED component 20 and the second LED component 30.

Optionally, the first power supply circuit 40 and the second power supply circuit 50 are power supply circuits each carrying a battery in the prior art or transformer circuits connected with direct current or current power, details of which are not illustrated herein.

Optionally, a power supply power of the first power supply circuit 40 is greater than a power supply power of the second power supply circuit 50, and the power supply power of the first power supply circuit 40 is more than 2 times of the power supply power of the second power supply circuit 50.

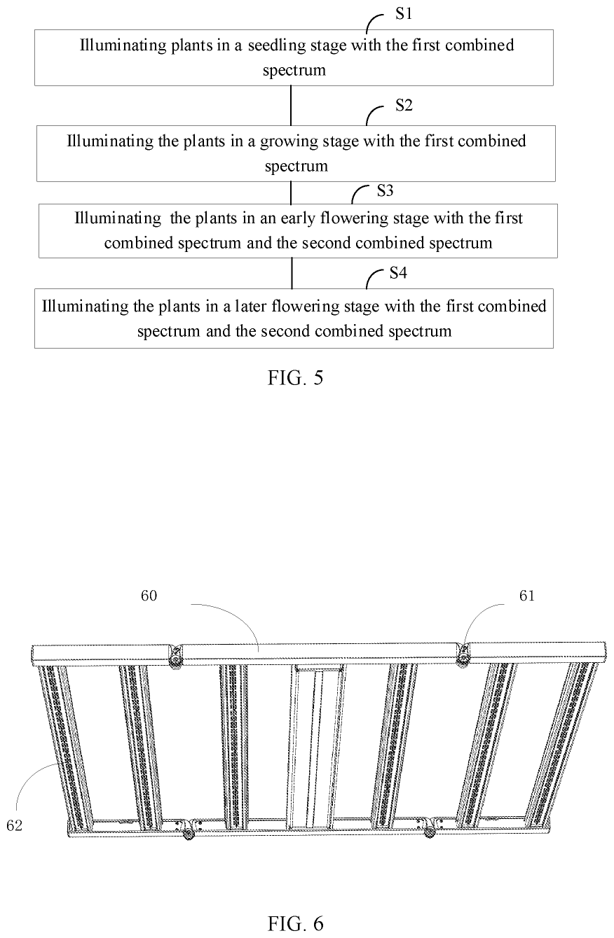

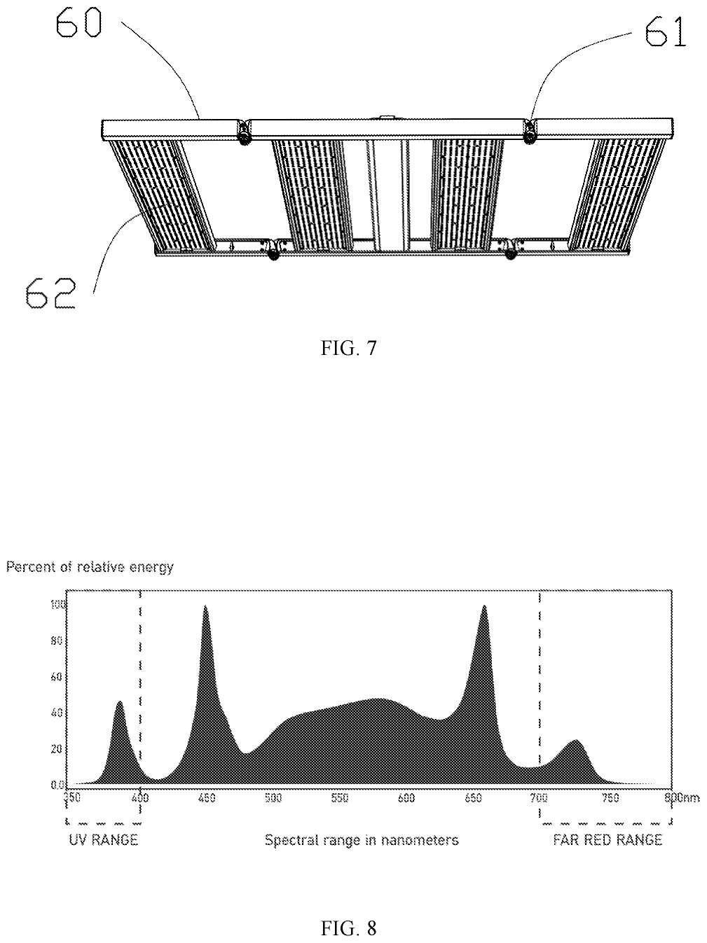

In one optional embodiment, as shown in FIG. 5, the plant full-cycle growth illuminating device is configured to implement an illuminating method. The illuminating method comprises:

S1: illuminating plants in a seedling stage with the first combined spectrum;

The first combined spectrum is determined according to the spectrum required for seedling growth. In a case of large-scale planting, if other conditions, such as water and air temperature, meet needs of plant growth, the first combined spectrum ensures good development of the plants in the seedling stage.

S2: illuminating the plants in a growing stage with the first combined spectrum;

Since the first combined spectrum is determined according to the spectrum required for seedling growth, the first combined spectrum is used during the growing stage. In the case of large-scale planting, if the other conditions, such as water and air temperature, meet the needs of plant growth, the first combined spectrum ensures good development of the plants in the growing stage.

When carrying out actual cultivation, the illuminating problem of the plants is solved by controlling LEDs of the first LED component to irradiate according to a specific proportion. It should be noted that the light output intensity of the first combined spectrum at this time is fine-adjusted according to actual needs to ensure further adapted to the plants in the growing stage.

S3: illuminating the plants in an early flowering stage with the first combined spectrum and the second combined spectrum; and

S4: illuminating the plants in a later flowering stage with the first combined spectrum and the second combined spectrum.

In the embodiment, by illuminating the plants in the growing stage with the first combined spectrum and illuminating the plants in a flowering stage with the first combined spectrum and the second combined spectrum, the plants in the seeding stage and the plants in the growing stage under the first combined spectrum are well developed, and comprehensive growth needs of the roots, stems and leaves of the plants are promoted. Further, by illuminating the plants, such as cultivated plants, in the early flowering stage and the cultivated plants in the later flowering stage with the first combined spectrum and the second combined spectrum, effective components in the cultivated plants are increased during the flowering stage, thereby increasing content of the effective components of the cultivated plants that are illuminated, which solves a technical problem in the prior art that the content of the effective components of the cultivated plants varies greatly during large-scale planting.

Optionally, in the seedling stage, the light output intensity of the first combined spectrum is defined as a first light intensity, in the growing period, the light output intensity of the first combined spectrum is defined as the second light intensity, and the first light intensity is less than the second light intensity.

The first light intensity is less than the second light intensity. which prevents the cultivated plants from cannot growing normally due to illuminating by too strong light in the seedling stage. The second light intensity is increased in the growing stage relative to the first light intensity, which greatly promotes growth of the stems and the leaves of the cultivated plants. Specific values of the first light intensity and the second light intensity are slowly adjusted during the growth of the cultivated plants. For a certain type of plants, the growth cycle thereof may be refined to daily or hourly through experiments, and then an optimal illuminating strategy matching a corresponding growth stage is obtained to make the plants grow more robustly. At this time, it necessary to consider in combination with the subsequent flowering stage of the plants, that is, the first combined spectrum having different light output intensities should be matched with the second combined spectrum having the same light output intensity, so the second light intensity has a specific value to promote the content of the effective components to the utmost extent in the later flowering stage.

Optionally, the flowering stage comprises the early flowering stage and the later flowering stage, the step of illuminating the plants in the flowering stage with the first combined spectrum and the second combined spectrum further comprises:
illuminating the plants in the early flowering stage with the first combined spectrum having a third light intensity and the second combined spectrum having a fourth light intensity; and
illuminating the plants in the later flowering stage with the first combined spectrum having a fifth light intensity and the second combined spectrum having a sixth light intensity.

The plants in the early flowering stage and the plants in the later flowering stage are illuminated by the first combined spectrum having different light intensities and the second combined spectrum having different light intensities to provide the spectrum required for plant growth. The first combined spectrum having the third light intensity and the second combined spectrum having the fourth light intensity ensure the growth of the plants in the early flowering stage, then the third light intensity and the fourth light intensity are respectively changed to the fifth light intensity and the sixth light intensity in the later flowering stage, that is, the spectrum mainly playing a role in the growth of the stems and the leaves is changed, avoiding re-growth of the stems and the leaves, and further increasing the content of the effective components in the cultivated plants.

Optionally, the first light intensity is 50%, and the second light intensity is 100%.

When the plants are illuminated with the first combined spectrum having the first light intensity, the plants are in the seedling stage, and the photosynthesis of the plants in the seedling stage is dominated by blue light, which promotes the growth of the roots, the stems, and the leaves of the plants. Because the plants are still in the seedling stage, a required light intensity PPFD (Photon flux density) does not need to be too high, so the light intensity is set to 50%. At this time, the first light intensity is able to be fine-adjusted according to a variety of the plants, which avoids damages of the light to the leaves of the plants, and ensures sufficient light to promote rapid growth of rhizomes of the plants. When the plants are illuminated with the first combined spectrum having the second light intensity, the plants are in the growing stage, and the photosynthesis of the plants in the growing stage is dominated by the blue light, which promotes large-area growth of the stems and the leaves of the plants and increases a fiber yield. Because the plants are in the growing stage, a required light intensity is the highest, so the second light intensity is adjusted to 100%. At this time, the second light intensity may also be fine-adjusted according to the variety of the plants.

Optionally, the third light intensity is 50%, the fourth light intensity is 100%, the fifth light intensity is 100%, and the sixth light intensity is 80%.

At this time, the first combined spectrum having the third light intensity of 50% and the second combined spectrum having the fourth light intensity of 100% correspond to a spectrum for the plants in the early flowering stage. The photosynthesis of the plants in the early flowering stage is dominated by the blue light, and is assisted by red light. The red light contains far-red light, which further ensure an accumulation of plant fibers in the early flowering stage. The first combined spectrum having the fifth light intensity of 100% and the second combined spectrum having the sixth light intensity of 80% correspond to a spectrum for the plants in the late flowering stage, which avoids the re-growth of the stems and the leaves of the plants in the late flowering period, and also promotes a yield of grain or ripening of lower fruits of fiber plants, and greatly increases the content of the effective components in the plants.

In one optional embodiment, the illuminating method further comprises:
determining an illumination receiving surface covered by the first LED component 20 and the second LED component 30;
The illumination receiving surface refers to a growth plane of the plants. After the plant full-cycle growth illuminating device composed of the first LED component 20 and the second LED component 30 is installed and turned on, an illumination range of the plant full-cycle growth illuminating device covers the growth plane of the plants to ensure the normal growth of the plants. The illumination range is determined through experiments in a laboratory. The illumination receiving surface changes with a height of the plant full-cycle growth illuminating device, and a size of the illumination receiving surface corresponding to a specific height of the plant full-cycle growth illuminating device is measured in the laboratory.
determining a quantity of first target light quanta in the illumination receiving surface according to a real-time growth stage;

It is noted that the plants in different growth stages have inconsistent requirements for the quantity of the light quanta.

For example, when the plants are in the growing stage, a demand for the light quanta is small because the leaves are growing. In the flowering stage, the leaves are well-grown, but there are more requirements for light quanta of a certain characteristics. Therefore, it is necessary to determine the quantity of the first target light quanta in the illumination receiving surface according to a real-time stage of the plants. At this time, the quantity of the first target light quanta is determined for a purpose of ensuring the normal growth of the plants, and a specific value of the first target light quanta are confirmed by specific plant species.
obtaining a quantity of actual light quanta of the illumination receiving surface; and

At this time, measurement of the quantity of the actual light quanta is realized by a measurement device such as a photon quantum meter.
adjusting the light output intensity of the first combined spectrum and the light output intensity of the second combined spectrum when the quantity of the actual light quanta is less than the quantity of the first target light quanta, enabling the quantity of the actual light quanta in the illumination receiving surface is not less than the quantity of the first target light quanta.

In the embodiment, while ensuring that the spectrum is suitable for the plants in different growth stages, it further ensured that the quantity of the light quanta in the illumination receiving surface meets the needs of the real-time growth stage, and illumination of the illumination receiving surface is accurate to avoid local yield reduction when the quantity of the light quanta in the illumination receiving surface cannot meet the requirements, thus improving a consistency of plant growth.

In one optional embodiment, the illuminating method further comprises:
obtaining environmental parameters of the illumination receiving surface, where the environmental parameters comprises a temperature, a humidity, a CO₂ concentration, and a wind speed;
determining a quantity of second target light quanta in an illumination receiving surface according to a real-time growth stage and the environmental parameters; and

It should be noted that, for a specific variety of the plants, the quantity of the second target light quanta in the illumination receiving surface is determined according to the real-time growth stage and the environmental parameters, which is obtained through separate control and mixed control experiments in the laboratory. An optimal solution with highest matching degree is obtained under a purpose of maximizing photosynthetic efficiency of the plants in the illumination receiving surface, which is not illustrated therein.
adjusting the light output intensity of the first combined spectrum and the light output intensity of the second combined spectrum according to the quantity of the second target light quanta, so that photosynthesis efficiency of the plant in the illumination receiving surface is maximized.

In the embodiment, the quantity of the second target light quanta is matched with the real-time growth stage of the plants and current environmental parameters, so that the plants grow at a high speed and further to bloom, and the photosynthesis efficiency of the plants in the illumination receiving surface is maximized.

In one optional embodiment, the plant full-cycle growth illuminating device further comprises a third LED component and a fourth LED component. The third LED component and the fourth LED component are respectively connected to the control circuit 10.

The third LED component outputs a third combined spectrum when the third LED component is lit. The fourth LED component outputs a fourth combined spectrum when the fourth LED component is lit. The control circuit 10 is further configured to respectively control a light output intensity of the third combined spectrum and a light output intensity of the fourth combined spectrum according to the user instruction.

At this time, the third LED component and the fourth LED component are set with reference to settings of the first LED component 20 and the second LED component 30, so as to construct a growing system including sets of the plant full-circle growth illuminating devices.

In one optional embodiment, the first LED component 20 comprises a first white lamp and a first red lamp. The second LED component 30 comprises a second white lamp, a second red lamp, a third far infrared lamp, and an ultraviolet lamp. A spectrum of the first white lamp and a spectrum of the first red light form the first combined spectrum. A spectrum of the second white lamp, a spectrum of the second red lamp, a spectrum of the third far infrared lamp, and a spectrum of the ultraviolet lamp form the second combined spectrum.

When the plant full-cycle growth illuminating device is configured for full-cycle illuminating of the plants, the first LED component is connected to the first power supply circuit to illuminate the plants through the first combined spectrum having the first light intensity during the seedling stage of the plants. During the growing stage of the plants, the first LED component is connected to the first power supply circuit to illuminate the plants through the first combined spectrum having the second light intensity. During the flowering stage of the plants, the first LED component is connected to the first power supply circuit and the second LED component is connected to the second power supply circuit to illuminate the plants through the first combined spectrum and the second combined spectrum.

In the embodiment, by illuminating the plants in the growing stage with the first combined spectrum and illuminating the plants in the flowering stage with the first combined spectrum and the second combined spectrum, the plants in the seeding stage and the plants in the growing stage under the first combined spectrum are well developed, and comprehensive growth needs of the roots, stems and leaves of the plants are promoted. Further, by illuminating the plants in the flowering stage with the first combined spectrum and the second combined spectrum, the effective components in the plants are increased during the flowering stage, thereby increasing content of the effective components of the cultivated plants that are illuminated, which solves the technical problem in the prior art that the content of the effective components of the cultivated plants varies greatly during large-scale planting.

In addition, at least two LED components (i.e., the first LED component and the second LED component) are applied to provide full-cycle plant growth lights, which avoids the need for the users to replace growth lights during large-scale planting, and are able to adapt to the full-cycle growth of the plants.

In one optional embodiment, the control circuit 10 comprises a controller and a multi-channel dimmer. The controller is connected to the multi-channel dimmer, and the multi-channel dimmer is connected to the first LED component 20 and the second LED component 30.

The controller is configured to obtain the user instruction and output a plurality of dimming signals corresponding to the first LED component and the second LED component according to the user instruction. The multi-channel dimmer is configured to output the plurality of dimming signals respectively to the first LED component or the second LED component, so as to separately control the first LED component and the second LED component. The plurality of dimming signals respectively control the first LED component 20 and the second LED component 30 to light up, and also control the light output intensity of the first LED component 20 and the light output intensity of the second LED component 30. FIG. 8 is a schematic diagram of a full mixed spectrum of the first combined spectrum and the second combined spectrum of the plant full-cycle growth illuminating device of the present disclosure.

The above description of the disclosed embodiments enables those skilled in the art to implement or use the present disclosure. A variety of modifications to these embodiments are apparent to those skilled in the art, and general principles defined in the specification can be implemented in other embodiments without departing from the spirit or scope of the present disclosure. Thus, the present disclosure should not be limited to the embodiments disclosed herein, and should be subject to the widest scope consistent with the principles and novel features disclosed herein.

What is claimed is:

1. A plant full-cycle growth illuminating device, comprising:
a control circuit,
a first light emitting diode (LED) component, and
a second LED component,
wherein the first LED component and the second LED component are respectively connected to the control circuit; the first LED component outputs a first combined spectrum when the first LED component is lit up; the second LED component outputs a second combined spectrum when the second LED component is lit up; the control circuit is configured to obtain a user instruction and respectively control a light output intensity of the first combined spectrum and a light output intensity of the second combined spectrum according to the user instruction; wherein the first combined spectrum and the second combined spectrum have different spectral compositions.

2. The plant full-cycle growth illuminating device according to claim 1, wherein the plant full-cycle growth illuminating device further comprises a first power supply circuit and a second power supply circuit; the first power supply circuit is connected to the first LED component and the control circuit, and the second power supply circuit is connected to the second LED component and the control circuit;
wherein the control circuit is configured to determine a first combined spectrum control signal and a second combined spectrum control signal according to the user instruction;
wherein the first power supply circuit is configured to supply power to the first LED component according to the first combined spectrum control signal, so as to adjust the light output intensity of the first combined spectrum; and
wherein the second power supply circuit is configured to supply power to the second LED component according to the second combined spectrum control signal, so as to adjust the light output intensity of the second combined spectrum.

3. The plant full-cycle growth illuminating device according to claim 1, wherein the plant full-cycle growth illuminating device is configured to implement an illuminating method; the illuminating method comprises:
illuminating plants in a seedling stage with the first combined spectrum;
illuminating the plants in a growing stage with the first combined spectrum; and
illuminating the plants in a flowering stage with the first combined spectrum and the second combined spectrum.

4. The plant full-cycle growth illuminating device according to claim 3, wherein the illuminating method further comprises:
determining an illumination receiving surface covered by the first LED component and the second LED component;
determining a quantity of first target light quanta in the illumination receiving surface according to a real-time growth stage of the plants;
obtaining a quantity of actual light quanta of the illumination receiving surface; and
adjusting the light output intensity of the first combined spectrum and the light output intensity of the second combined spectrum when the quantity of the actual light quanta is less than the quantity of the first target light quanta, enabling the quantity of the actual light quanta in the illumination receiving surface is not less than the quantity of the first target light quanta.

5. The plant full-cycle growth illuminating device according to claim 3, wherein the illuminating method further comprises:
obtaining environmental parameters of the illumination receiving surface, where the environmental parameters comprises a temperature, a humidity, a CO₂ concentration, and a wind speed;
determining a quantity of second target light quanta in an illumination receiving surface according to a real-time growth stage of the plants and the environmental parameters;
adjusting the light output intensity of the first combined spectrum and the light output intensity of the second combined spectrum according to the quantity of the second target light quanta, so that photosynthesis efficiency of the plants in the illumination receiving surface is maximized.

6. The plant full-cycle growth illuminating device according to claim 1, wherein the plant full-cycle growth illuminating device further comprises a third LED component and a fourth LED component; the third LED component and the fourth LED component are respectively connected to the control circuit;
wherein the third LED component outputs a third combined spectrum when the third LED component is lit up; the fourth LED component outputs a fourth combined spectrum when the fourth LED component is lit up;
wherein the control circuit is further configured to respectively control a light output intensity of the third combined spectrum and a light output intensity of the fourth combined spectrum according to the user instruction.

7. The plant full-cycle growth illuminating device according to claim 1, wherein the first LED component comprises a first white lamp and a first red lamp; the second LED component comprises a second white lamp, a second red lamp, a third far infrared lamp, and an ultraviolet lamp; a spectrum of the first white lamp and a spectrum of the first red light form the first combined spectrum; a spectrum of the second white lamp, a spectrum of the second red lamp, a spectrum of the third far infrared lamp, and a spectrum of the ultraviolet lamp form the second combined spectrum.

8. The plant full-cycle growth illuminating device according to claim 1, wherein the control circuit comprises a controller and a multi-channel dimmer; the controller is connected to the multi-channel dimmer, and the multi-channel dimmer is connected to the first LED component and the second LED component; the controller is configured to obtain the user instruction and output a plurality of dimming signals corresponding to the first LED component and the second LED component according to the user instruction; the multi-channel dimmer is configured to output the plurality of dimming signals respectively to the first LED component or the second LED component, so as to separately control the first LED component and the second LED component.
